(19) United States
(12) Patent Application Publication
(10) Pub. No.: US 2024/0316835 A1
(43) Pub. Date: Sep. 26, 2024

(54) MOLDING TOOL FOR PRODUCING MOLDED PARTS AND METHODS FOR PRODUCING MOLDED PARTS USING A MOLDING TOOL

(71) Applicant: Kiefel GmbH, Freilassing (DE)

(72) Inventors: Johannes Marius van der Schans, Sprang-Capelle (NL); Cornelis Hendrikus Albertinus Decoz, Sprang-Capelle (NL)

(21) Appl. No.: 18/609,703

(22) Filed: Mar. 19, 2024

(30) Foreign Application Priority Data
Mar. 20, 2023 (DE) 10 2023 106 948.9

(51) Int. Cl. B29C 43/44; B29C 43/32

(52) U.S. Cl. CPC B29C 43/44; B29C 2043/3283

(57) ABSTRACT

A molding tool and a method for producing molded parts from a moldable material with at least one first tool component and at least one second tool component are described. The first tool component has a cavity with a first molding surface and the second tool component has a molding element with a second molding surface, which has an at least partially flexible material. Moldable material introduced into the cavity is pressed against the first molding surface at least in certain regions by the deformation of the flexible material. A medium is introduced via the molding element for this purpose, which leads to deformation of the flexible material.

### PRIORITY CLAIM

The present application claims priority under 35 U.S.C. § 119 to German Patent Application No. DE 10 2023 106 948.9, filed Mar. 20, 2023, the disclosure of which is incorporated by reference herein in its entirety.

### TECHNICAL FIELD

A molding tool for producing molded parts made of a moldable material and a method for producing molded parts made of a moldable material using a molding tool are described. For example, films made of plastic, films with openings, for example with a net-like structure, and/or fiber-containing materials, can be used as moldable material.

### DESCRIPTION OF RELATED ART

For molding and/or pressing moldable materials, molding tools are generally used, wherein the moldable material is introduced into a cavity and is deformed there by pressure or by generating overpressure or negative pressure in the cavity or a mold chamber. An introduction of gas/gas mixture (e.g., molding air) into the cavity or the generation of a vacuum are used in conventional thermoforming. In this case, for example, a film in the cavity is either pressed through the overpressure against a molding wall of the cavity or a film is sucked onto the molding wall of a cavity.

When molding molded parts made of a fiber-containing material, the material is generally introduced and pressed there between molding surfaces of a molding tool, wherein, in contrast to molding in films, a reduction in the wall thickness of the preform to be pressed at the same time is at a very high temperature (>200° C.). For example, a preform can thereby be introduced into the cavity, which differs from the product to be produced with regard to moisture, shape, size and thickness. Furthermore, loose fibers can also be introduced into a cavity and pressed between the molding surfaces of a molding tool.

Various tool designs are therefore always required for molding the different materials. In addition, the corresponding tool designs have different disadvantages. The molding for products is thus greatly limited, for example with regard to undercuts and edges at the base of the products or molded parts. In the prior art, products formed in this way can be produced only with a high effort and using complex molding tools, which have a plurality of moving components. Furthermore, it is not possible, for example, with conventional thermoforming tools to form films with openings, for example a net-like structure, since an overpressure or negative pressure cannot provide any deformation in the cavity, because the compressed air introduced or drawn in through the openings leads to a pressure equalization on both sides of the film.

Furthermore, in conventional thermoforming, it is necessary to provide overpressure or negative pressure in order to deform a film.

### SUMMARY

### Object

In contrast thereto, an object of the present disclosure is to specify a solution for producing molded parts from a moldable material, which eliminates the disadvantages of the prior art and in which a deformation is achieved using simple means with simultaneously reduced use of aids, which deformation is not subject to restrictions with regard to the shape of the molded parts to be produced.

### Solution

The object mentioned above is achieved by a molding tool for producing molded parts made of a moldable material with at least one first tool component and a second tool component, wherein
the first tool component has a cavity into which moldable material can be introduced,
the second tool component has a molding element, which can be introduced into the cavity of the first tool component in order to produce a molded part,
the molding element has a second molding surface via which, in the closed state of the molding tool, moldable material can be pressed against a corresponding first molding surface of the cavity of the first tool component, and
at least one portion of the second molding surface has a flexible material which, in the closed state of the molding tool, is deformable by introducing a medium via the molding element in order to press the moldable material against the first molding surface.

The molding tool makes it possible, for example, to deform films made of plastic, wherein, compared to conventional thermoforming tools and methods, significantly less molding air is required for deformation, because the deformation cannot take place by generating negative pressure or overpressure if the flexible material forms, for example, the entire second molding surface, but rather by the deformation of the flexible material. For this reason, the design of the molding tool can therefore also be simpler since no sealing has to take place in order to generate negative pressure or overpressure regions. Furthermore, with such a molding tool, net-like films made of plastic can also be deformed, because no negative pressure or overpressure is necessary for the deformation.

The molding element can also serve as a stretching aid and a film, the same as whether it is designed to be net-like or closed, can advance before a final molding, which is carried out, for example, by the deformation of the flexible material, wherein the film is pressed into a cavity.

Furthermore, molded parts can also be shaped from a fiber-containing material using such a molding tool. Such a molding tool can be used, for example, both for pressing dry fibers (“dry fiber”) and a moist preform (“wet fiber”). A moldable material is classed as wet material from a water content of around 30 wt. %. A material having a water content of less than 30% by weight is referred to as a dry material.

In the production of molded parts made of a fiber-containing material, fiber-containing material can first be introduced into the cavity, wherein a fiber layer rests against the first molding surface. Applying the fiber layer can also be supported by introducing the molding element, which presses the fibers against the first molding surface. For this purpose, the flexible material can in particular have a relatively large wall thickness, wherein the flexible material can yield at least slightly when the fiber-containing material is pressed. Subsequently, a medium is introduced so that the flexible material is deformed and expands so that the fiber-containing material is compressed and pressed against the first molding surface. For this purpose, for example, the second molding surface can be completely formed by the flexible material. In this case, the introduced fiber layer is pressed. For this, due to the deformation of the flexible material, a reduction of the distance between the first molding surface and the surface of the second tool component occurs, so that the fiber layer is compressed. The fiber layer is pressed so that a connection of the fibers can be achieved. In further embodiments, water can additionally or alternatively be pressed out during overpressure by the compression of the fiber material.

Depending on the design of the second tool component and the molding element, in further embodiments, the second molding surface can have, for example only in regions, a flexible material, so that a deformation of the second molding surface also takes place only in regions in the cavity, i.e., it is only in corresponding regions of the first molding surface that a film or a fiber material is pressed against or additionally pressed against the flexible material. A combination of molding via a molding die and a flexible material can thus also be provided in further embodiments, for example for a film with a net-like structure. In this case, a molding die can serve not only as a stretch feeder, wherein a film is pushed into the cavity and pre-formed but is also pressed against the first molding surface of the cavity via the second molding surface of the molding element, which can be partially formed by the molding die. An additional deformation can then take place via the flexible material, for example to form an undercut.

In further embodiments, the cavity can have at least one undercut and the moldable material can be pressed into the undercut of the cavity by the at least one section of the second molding surface, which at least partially has a flexible material. A moldable material, fiber-containing material or, for example, plastic material (film; net structure) can be pressed substantially against the first molding surface of the cavity via the second molding surface of a molding die (molding element), wherein the undercut remains free. The flexible material is only deformed when the medium is introduced and the moldable material is pressed into the undercut and finally deformed. In this case, the at least one section of the second molding surface with the flexible material can lie opposite a region of the first molding surface with the at least one undercut when the molding tool is closed.

In further embodiments, the second molding surface immersing into the cavity of the first tool component in the closed state of the mold can have a flexible material or be formed entirely by a flexible material, so that substantially the entire second molding surface is deformed by the introduction of a medium (gas, gas mixture, fluid) and causes the final deformation of the moldable material introduced into the cavity. In this case, final molding is only achieved via the flexible material, wherein no negative or positive pressure has to be generated in the cavity and therefore, for example, less molding air is required, which is only introduced via channels in the molding element to shape the flexible material, for example. In such designs, for example, a defined material distribution of the moldable material in the cavity can be achieved via the flexible material, because the moldable material is not sucked in, for example, but pressed over the flexible material. For example, heated plastic of a film can be in contact with the molding surfaces within a cavity between the first molding surface and the second molding surface prior to the introduction of a medium. If medium is now introduced, the heated plastic can be displaced from this region into neighboring regions, which have a greater distance between the first molding surface and the second molding surface before the medium is introduced and therefore more space for the plastic.

In further embodiments, the second molding surface can have regions with a different structure or material thickness of the flexible material, so that the flexible material is not deformed uniformly or expands when the medium is introduced. In further embodiments, different material thicknesses of the moldable material can be achieved, for example, with essentially smooth surface regions of the first molding surface if the flexible material does not deform uniformly. Furthermore, it is possible that uniform pressing/compression of moldable material can be achieved in regions of the first molding surface if the first molding surface has, for example, grooves or other elevations and/or bulges. Finally, a material thickness of the molded part to be produced can also be formed differently via its geometry (e.g., thicker or thinner base region of a cup).

In further embodiments, the second molding surface can have at least two different flexible materials, which differ with respect to the formability of the flexible material, so that, as described above, different material thicknesses of the moldable material can be achieved in the finished molded part and/or that a corresponding design of the first molding surface can be taken into account in order to achieve a constant material or wall thickness of a product to be manufactured.

In further embodiments, the flexible material can extend in a ring around the molding element so that, for example, undercuts can be easily created. In such embodiments, the molding element may, for example, have a substantially flat surface that substantially corresponds to the shape of the molded part to be produced. The flexible material can be located in a circumferential groove of the molding element in the non-actuated state, so that it does not protrude from the rest of the surface in this state. The flexible material is only deformed when the medium is introduced, which then emerges from the groove or a similar recess in the molding element and thus causes (further) deformation of the moldable material. By using a flexible material, it is therefore also possible to create wave-like undercuts, for example, because the flexible material can follow the contour of such an undercut without difficulty. This results in a greater variety in the production of molded parts and the creation of functional elements (recessed grips, retaining grooves, logos, etc.) and undercuts.

In further embodiments, the flexible material can lie against the molding element in a resting state, which represents the non-actuated state, wherein no medium is introduced, and the molding element can have openings for the medium to deform the flexible material in regions with a flexible material. The medium is introduced via the openings, which causes the flexible material to be deformed. The number and position of the openings and the channels can significantly influence the deformation behavior of the flexible material, so that the deformation of the flexible material and thus ultimately also the formation and wall thickness of the moldable material can be influenced.

In further embodiments, the openings may differ from one another in shape, design and/or position, e.g., opening width, diameter; cross-section, length, etc., depending on the material thickness of the flexible material, the composition of the flexible material, the position/location of the flexible material, the flexible material used and/or the design of the first molding surface. For example, the deformation of flexible material can be specifically influenced by the number, arrangement and design of the openings. The openings can also be formed in accordance with the selection of flexible materials and/or the design of the first molding surface and ultimately also the molded part to be produced. In further embodiments, in addition or as an alternative to a special design of the openings, channels to the openings in the molded body can have a corresponding shape, course, cross-section, etc., influence the outlet (direction, quantity, volume flow) of the introduced medium in order to achieve a definable deformation of the flexible material for the formation of the molded part.

In further embodiments, the amount of medium to regions with a flexible material can be controlled via devices so that, for example, the amount of medium is different, medium is supplied at different times and/or is maintained for different lengths of time. This allows the deformation to be controlled over time, for example, so that regions of the molded part to be produced can also be formed differently. For example, a side wall can first be created by deformation and then a groove structure or an undercut can be created with a time delay. During the molding process, temperature changes can play a role, so that deformations that take place at different times can also vary in intensity, as the material in question cools down or heats up additionally, for example. Such devices can be, for example, valves or separate feeding devices for media, each of which are or can be controlled separately.

In further embodiments, the deformability of both the flexible material and the moldable material can also be influenced by controlling the temperature of a medium in order to produce differently deformed molded parts with different material distributions and/or wall thicknesses. For example, separate temperature control devices can be provided for heating/cooling a medium.

The molding element can, for example, be made of a non-deformable material, such as a metal or a metal alloy. In further embodiments, the molding element can be made of a plastic that is essentially non-deformable.

In further embodiments, the flexible material may additionally or alternatively have reinforcements and/or weak points, which influence the deformability of the flexible material.

In addition, the flexible material can be made of different materials that differ in terms of the formability of the flexible material.

In further embodiments, the second molding surface may have at least two sections made of a flexible material that differ with respect to the deformability of the flexible material. For example, differently shaped undercuts can be created that differ from each other in terms of depth, size and/or position. In this way, for example, different degrees of deformation and/or defined wall thicknesses can be achieved at the same pressure using a gas mixture as the medium.

In further embodiments, the flexible material may include or be made of silicone and/or thermoplastic elastomers. Depending on the required deformation due to the geometry and design of a molded part and the resulting geometry and shape of a cavity or the first molding surface, materials with different deformability can be used. When selecting flexible materials, it is also important to consider whether the moldable material is compatible with the flexible material so that the moldable material and the flexible material are not damaged or impaired. The temperatures to which the flexible material is exposed must also be taken into account. Particularly when producing molded parts from a wet, fiber-containing material, the fiber material is often additionally heated during pressing. Appropriate silicones and thermoplastic elastomers must therefore be selected. For example, a temperature resistance of up to 300° C. may be required for the flexible material.

In further embodiments, the first molding surface can have second openings through which water vapor generated during pressing and simultaneous heat supply can be extracted or removed from a fiber-containing material during the production of molded parts.

In further embodiments, the first molding surface may have second openings through which water vapor generated during pressing and simultaneous heat supply can be extracted or removed.

In further embodiments, the cavity of the first tool component and/or the molding element of the second tool component can be heated via at least one heating device, so that, for example, the moisture of material containing fibers can be reduced and/or the bonding of fibers can be improved or supported. Plastic films can also be more easily deformed under the influence of heat in other applications. Heating devices can include, for example, cartridge heaters, inductive heating devices, etc.

The aforementioned object is also solved by a method for producing molded parts from a moldable material using a molding tool with at least one first tool component and at least one second tool component, wherein the first tool component has a cavity with a first molding surface, and wherein the second tool component has a molding element with a second molding surface, which at least partially has a flexible material that forms at least a portion of the second molding surface, having the following steps:
Introducing moldable material into a cavity of at least a first tool component,
Introducing a molding element of a second tool component into the cavity of the at least one first tool component by relative displacement of the at least one first tool component and the molding element, wherein a second molding surface of the molding element moves the moldable material at least in regions against the first molding surface, and
Introducing a medium via the molding element in the region of the flexible material, wherein the flexible material is deformed and the deformation causes the flexible material to press the moldable material against a corresponding section of the first molding surface.

The method can be used to produce moldable material with a lower media input (e.g., method air) compared to known thermoforming methods, wherein the mold design and the manufacturing method can be used for different moldable materials. Depending on the design of the molding tool, the introduction of a medium can be controlled by the position of the molding element in such a way that a medium is only introduced once the molding element has reached bottom dead center. Depending on the design of the molding element and the formation of the second molding surface, the bottom dead center of the molding element can be reached, for example, when the moldable material introduced is in contact with both the first molding surface and the second molding surface. This embodiment can be present, for example, if the base region of the molding element or the second molding surface is not formed by a flexible material and is therefore not deformed by the introduction of a medium, wherein in further embodiments with a base region made of flexible material, it is possible to displace plastic, for example, into side or edge regions. In further embodiments with a flexible material in the region of the base of the second molding surface, the bottom dead center of the molding element may be present, depending on the intended deformation of the flexible material, if there is a distance between the first molding surface and the second molding surface that is greater than the material thickness of the moldable material introduced.

The method enables the production of molded parts and the formation of structures in a molded part by simple means, wherein regions with the flexible material are deformed by introducing a medium, which leads to a molding or additional molding of the moldable material. The embodiments and advantages given above for the molding tool apply correspondingly to the method described herein.

In further embodiments, the cavity can have at least one undercut and the moldable material can be pressed into the undercut of the cavity over the flexible material of the at least one section of the second molding surface when the medium is introduced. This provides a two-stage manufacturing method, which is characterized by the fact that pressure is exerted solely via the molding element and additional deformation is achieved by introducing a medium. It is therefore not necessary to move and control other molding tool parts.

In further embodiments, after the molding has been formed in the cavity, the introduction of medium can be terminated, wherein the flexible material resumes its shape prior to the introduction of medium and subsequently the molding element of the second tool component is moved out of the cavity.

In further embodiments, the supply of at least one medium for at least a partial region of at least one flexible material can be controlled in accordance with the geometry of the molded part to be produced, the properties and design of the flexible material used and/or the medium used. The control can affect the feed time, the feed duration, the pressure, which can be variable over time, and/or the temperature control of the medium. In still further embodiments, for example, a continuous or stepwise deformation of the regions with the flexible materials can be achieved with several flexible regions, which can be controlled separately and can be deformed by a medium, so that, for example, plastic is pressed continuously or stepwise from one region into at least one neighboring region.

In still further embodiments, for example, a groove-like structure (horizontal or vertical) on a molded part can be achieved by a number of regions with flexible material corresponding to the number of grooves, which are jointly subjected to medium and expand in a “bulgy-shaped” manner essentially along their longitudinal axis or line, so that regions in the molded part are produced between adjacent “bulgy-shaped” regions, which have a greater material thickness after molding.

Further features, embodiments and advantages result from the following illustration of exemplary embodiments with reference to the figures.

### BRIEF DESCRIPTION OF THE DRAWINGS

In the drawings:

FIG. 1 depicts a schematic representation of a fiber molding plant for producing products from a fiber material, according to some embodiments.

FIG. 2 depicts a schematic representation of a molding tool for producing molded parts, according to some embodiments.

FIG. 3 depicts a schematic representation of the molding tool in FIG. 2 after the introduction of a moldable material, according to some embodiments.

FIG. 4 depicts a schematic representation of the molding tool in FIG. 2 in a first molding step, according to some embodiments.

FIG. 5 depicts a schematic representation of the molding tool in FIG. 2 in a second molding step, according to some embodiments.

FIG. 6 depicts a schematic representation of the molding tool in FIG. 2 in a third molding step, according to some embodiments.

FIG. 7 depicts a schematic representation of the molding tool in FIG. 2 after molding the deformable material, according to some embodiments.

FIG. 8 depicts a schematic representation of the molding tool in FIG. 2 after a further processing step following molding, according to some embodiments.

FIG. 9 depicts a schematic representation of a molded part, according to some embodiments.

FIG. 10 depicts schematic representations of a molding tool for producing moldable materials in a further embodiment.

FIG. 11 depicts a schematic representation of a molding tool of a still further embodiment with moldable material inserted.

FIG. 12 depicts a schematic representation of the molding tool in FIG. 11 during the molding of the moldable material introduced, according to some embodiments.

FIG. 13 depicts a schematic representation of a molding tool in a still further embodiment after molding a moldable material, according to some embodiments.

FIG. 14 depicts a schematic representation of another molded part, according to some embodiments.

FIG. 15 depicts schematic representations of a molding tool for producing moldable materials in a still further embodiment.

FIG. 16 depicts a method for producing molded parts, according to some embodiments.

### DETAILED DESCRIPTION

Various embodiments of the technical teaching described herein are shown below with reference to the figures. Identical reference signs are used in the figure description for identical components, parts and processes. Components, parts and processes which are not essential to the technical teachings disclosed herein or which are obvious to a person skilled in the art are not explicitly reproduced. Features specified in the singular also include the plural unless explicitly stated otherwise. This applies in particular to statements such as “a” or “one.”

The figures show embodiments of devices for producing molded parts from a moldable material, wherein the embodiments shown do not represent any restriction with regard to further embodiments and modifications of the embodiments described.

The production of molded parts 200 from a moldable material is described below, wherein a film made of a plastic (e.g., PET, PP, PS, PLA, PE) is used as the moldable material. In further embodiments, the film can also have openings or a net-like structure, wherein separate reference is made to differences in the tool for the various moldable materials.

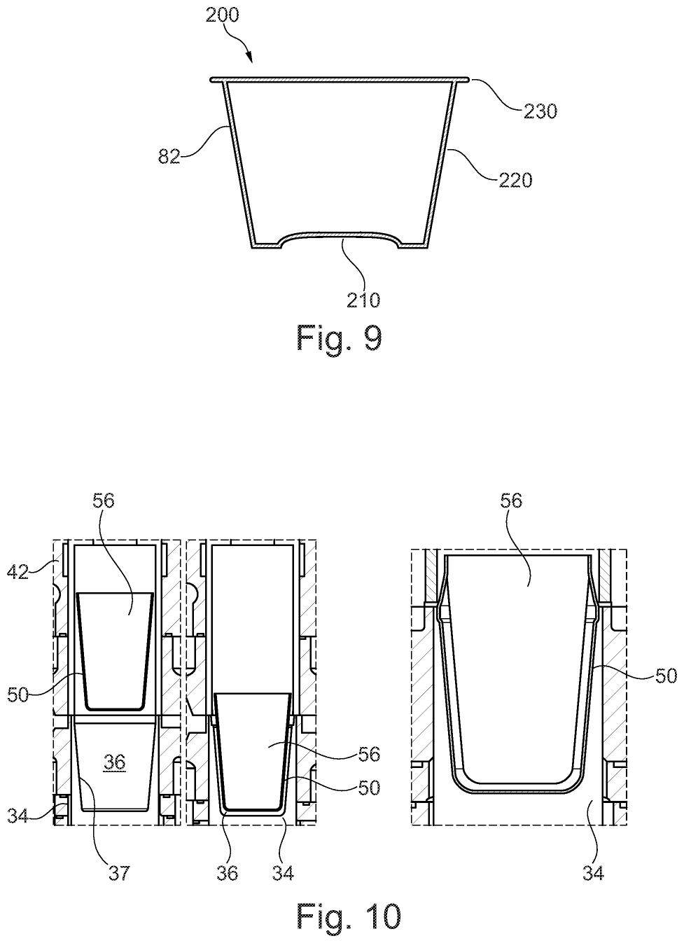

Instead of a plastic film, the molding tools 30 described below can also be used to produce molded parts 200 using fiber-containing material. This can be a dry fiber material as well as a moist or wet fiber material. Dry fiber material is usually referred to as having a water content of less than 30% by weight. A water content of approx. 30% by weight or more is referred to as wet fiber material. The fiber material can be present as a preform and can be further processed in a molding tool 30. Alternatively, fiber material without a structure or similar can be introduced into a cavity 36 of a molding tool 30 and formed there into a molded part 200. Usually, preforms already essentially have the shape of the molded part 200 to be produced. In particular, fiber-containing material can only contain natural fibers. A fiber-containing material can also have additives that affect the mechanical properties and the barrier effect. Depending on the composition of the fiber-containing material, molded parts produced from a fiber-containing, moldable material can be biodegradable and can themselves be used again as starting material for producing three-dimensional molded parts, such as a cup-like molded part 200 (see FIGS. 9, 14) made from a fiber-containing material, and can be composted, because these can generally be completely decomposed and do not contain any questionable, environmentally hazardous substances.

In particular, a molded part 200 can be a three-dimensional molded part 200, such as cups, lids, bowls, capsules, plates and other molded and/or packaging parts (e.g., as holder/support structures for electronic or other devices).

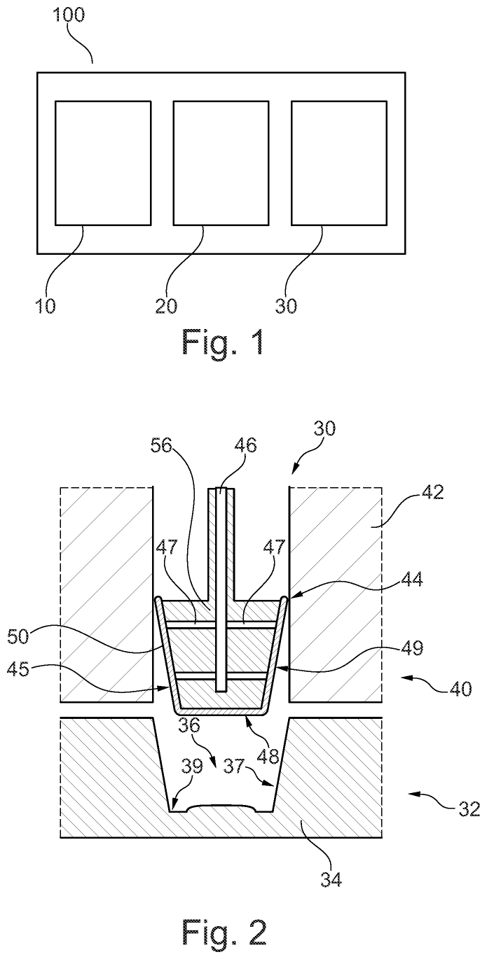

FIG. 1 shows a schematic representation of a molding device 100 for producing molded parts 200 from a moldable material, according to some embodiments. The molding device 100 has at least one control unit 10, a feeding device 20 and a molding tool 30 for molding a moldable material. The control unit 10 is used to control the processes and sequences of the molding device 100 and is connected to the corresponding equipment for this purpose. The control unit 10 regulates the energy requirement and material conversion and processes information and control commands for this purpose. The feeding device 20 is used to feed moldable material, for example a plastic film, between a first tool component 32 and a second tool component 40 of a molding tool 30, which has at least one cavity 36. In the molding tool 30 or before reaching the plastic film 80 supplied as a film web, the film web is heated and placed between the tool components 32 and 40. There, a molding element 44 stretches the preheated plastic film into the cavity 36. The plastic film 80 is then pressed against a first molding surface in the cavity 36 and the plastic film 80 is partially pressed over a flexible region 49 of the molding element 44 or the plastic film 80 is completely formed and pressed over a flexible region 49 of the molding element 44, which completely forms the second molding surface 45 for the final molding for producing molded parts 200. The manufactured molded part 200 is then removed from the cavity 36 and can be sent for further processing (coating, filling, sealing, printing, stacking, packaging, etc.). In further embodiments, a molding device 100 may have a molding tool 30 with a plurality of cavities 36 and corresponding molding elements 44 (see FIGS. 2 to 8, 10, 11 to 13, and 15).

In embodiments with a molding tool 30 for processing fiber-containing material, this material can be introduced as a preform, as a fiber mat or as loose fiber material via the feeding device 20 into at least one cavity 36 of at least one molding tool 30. In further embodiments, the fiber-containing material can be moistened in order to improve the bonding effect between the fibers of the fiber-containing material during subsequent pressing. For this purpose, steam is introduced into a cavity 36 after the fiber-containing material has been introduced into the cavity 36. Preferably, steam is introduced under pressure. To this end, steam can be introduced when the molding tool 30 is at least partially closed. In further embodiments, steam can be introduced directly into the fiber layer via channels and openings in first molding surfaces 37 and/or second molding surfaces 45 when the molding tool is closed. Suitable pressures are in the range of 1 to 25 bar, wherein the pressure depends on several factors (dimensions and geometry of the molded part 200 to be produced, layer thickness of the fiber layer, fiber-containing material as preform, mat or loose fibers, properties of the fiber-containing material, etc.). The introduction of moisture by means of steam has proven to be a very efficient process of quickly bringing moisture into the fibers of the fiber-containing material. In still further embodiments, a molding device 100 may also have a preforming station in which preforms are produced. In further embodiments, molding devices 100 may additionally or alternatively have a storage container for moldable material. Finally, a molding device 100 can have a device for removing and further processing molded parts 200.

FIG. 2 shows a schematic representation of a molding tool 30 for producing molded parts 200, according to some embodiments. The molding tool 30 has a first tool component 32 and a second tool component 40, which have a first tool plate 34 and a second tool plate 42, respectively. The tool plates 34 and 42 can, for example, be made of a metal or a metal alloy. In further embodiments not shown, a first tool plate 34 may have multiple cavities 36 disposed in the tool plate 34. In contrast to the embodiments shown, one or more molds with cavities 36 may be arranged on a tool plate 34. Such molds can, for example, be interchangeably connected to the tool plate 34, e.g., screwed together.

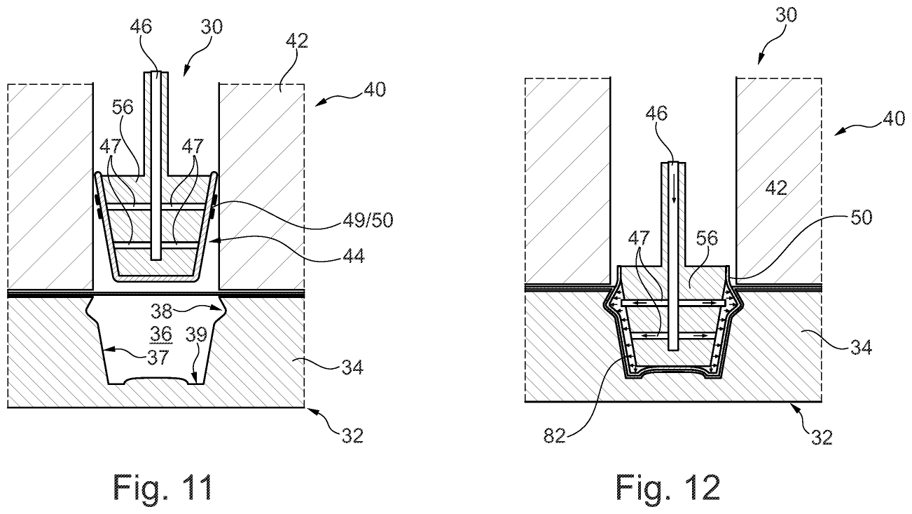

The cavity 36 has a shaping first molding surface 37. The first molding surface 37 defines the outer shape of the molded part 200 to be produced, which is a rotationally symmetrical body in the embodiment example shown. In further versions, non-rotationally symmetrical molded parts can also be produced in correspondingly shaped cavities. In further embodiments, the first molding surface 37 can have a circumferential undercut 38 in the upper region, as provided in the embodiment examples in FIGS. 11 to 13. The first molding surface 37 also has a peripheral edge region 39 in a lower base region. The surface of the tool plate 34 directly adjacent to the cavity 36 can form an annular molding surface, which serves to form an edge 230 of a molded part 200, as shown schematically in FIGS. 9 and 14, and can thus also be part of the first molding surface 37. In further embodiments, the surface of the first molding surface 37 may have a non-stick coating and/or be designed to reduce the adhesive effect. Heating devices can be provided below the first molding surface 37 and/or inside the first tool plate 34, which can be controlled via a control unit 10 in order to heat the first tool plate 34 and, via this, the first molding surface 37. By tempering the first molding surface 37, the deformation of an inserted material (e.g., polymer film or fiber-containing material) can be supported and specifically influenced.

A molding element 44 is arranged on the second tool plate 42, which is aligned with the cavity 36 arranged underneath in such a way that the molding element 44 can be inserted into the cavity 36. The molding element 44 may, for example, be connected to the tool plate 42 and a drive means via corresponding means in order to perform a downward movement in the direction of the cavity 36 as well as out of the cavity 36. In further embodiments with several cavities 36, several corresponding molding elements 44 are arranged on the tool plate 42.

The molding element 44 has a molded body 56, to the outer surface of which a flexible material 50 is attached. In the embodiment shown, the molded body 56 is made of metal (e.g., aluminum). In still further embodiments, the molded body 56 may be made of a hard, non-deformable plastic or a ceramic material. The flexible material 50 is connected to the molded body 56 in such a way that it can be removed from the molded body 56 by introducing compressed air or another medium. In the embodiment example shown in FIG. 2, the flexible material 50 is firmly connected to the molded body 56 in the upper region of the molded body 56, which is not used for pressing and molding an inserted moldable material, so that no compressed air introduced in the connection region can escape. In further embodiments, the attachment can take place at several points and be different to the embodiment shown. Furthermore, in versions with several flexible materials, these are each connected to a molded body 56 at corresponding points. Compressed air can be provided by a supply unit via a main channel 46 and secondary channels 47 in the molded body 56 and at least one supply channel in the connecting rod between the molded body 56 and other mold equipment, such as a drive, for example. In addition, compressed air can be extracted again via this supply unit. Valves and/or other devices can be provided to control the supply and discharge of the medium or compressed air introduced. In further embodiments, a medium or compressed air can also be introduced in different regions at different times and/or with a different pressure in order to deform a corresponding flexible material 50 located in these regions to a correspondingly greater or lesser extent or at different times.

The surface of the inserting molding region forms the second molding surface 45. Analogous to an annular surface as part of the first molding surface 37, the molding element 44 can have a corresponding opposite molding section, which can also be covered by the flexible material 50 and can also be deformed by means of an introduced medium (e.g., compressed air). This surface of the upper molding region of the molding element 44 opposite the annular surface of the first tool body 34 can also form part of the second molding surface 45. According to the embodiment of the cavity 36 for rotationally symmetrical molded parts 200, the molding element 44 is also rotationally symmetrical at least in the region required for molding molded parts 200 in the embodiment example shown.

In further embodiments, multiple secondary channels 47 may be provided, which are located in different regions of the molded body 56. The secondary channels 47 can also be curved, for example to ensure a directed outflow of compressed air or another medium. In addition, both the diameters and cross-sectional shapes of the secondary channels 47 and of the main channel 46 and of outlet openings for a medium on the surface of the molded body 56 can be designed differently in order to ensure a targeted introduction of compressed air so that the flexible material 50, which forms the second molding surface 45, behaves or deforms according to the required expansion for pressing moldable material. With regard to the selected embodiment, it should be considered whether the second molding surface 45 is formed entirely by the flexible material 50, or whether the flexible material 50 only forms a region of the second molding surface 45.

The flexible material 50 can, for example, be firmly bonded to the upper edge region of the molded body 56. When compressed air is introduced via the channels 46, 47, the flexible element 50 is then “inflated”, wherein the second molding surface 45 is pressed against the first molding surface 37 of the cavity 36. The connection of flexible material 50 to a molded body 56 can in principle be achieved by bonding or any other suitable connection process. In further embodiments, flexible material 50 can also be mechanically connected to the molded body 56. For example, fastening rings or a fastening sleeve can be used, which are pushed over a molded body 56.

In the embodiment example shown in FIG. 2, the second molding surface 45 is formed entirely by a flexible material 50. The flexible material used is such a material that has the required properties to be deformed from a determinable pressure via the medium introduced within the cavity 36, wherein an “air cushion” is formed between the deformed region of the flexible material 50 and the molded body 56.

The selection of flexible materials 50 must be made with regard to the desired deformation for producing molded parts 200, wherein the selection can also be made according to the material introduced, the geometry of the cavity 36 and the molded part 200 to be produced and the components involved in the manufacturing process as well as the properties of the materials used.

When deforming via the flexible material 50, care must be taken to ensure that a flexible material 50 is used in such a way and at such points that targeted deformation of the flexible material 50 can take place by introducing a medium.

Suitable materials for the flexible material 50 are, for example, thermoplastic elastomers or silicones. Additives can be incorporated into the flexible materials 50 to influence their formability. Alternatively or additionally, the deformation in this region can be adapted by inserting elements made of a different material, e.g., a wire ring or wire mesh, and thereby be less than in the section of a flexible material 50 without such elements. Furthermore, weak points may additionally or alternatively be formed in a flexible material 50. Weak points can be, for example, regions of the flexible material 50 with free spaces, wherein the free spaces can extend, for example, in a ring concentrically to the vertical axis through the cavity 36 and/or in a straight line along the second molding surface 45 (for example, on the side facing the molded body 56 to form flat second molding surfaces 45). Such free spaces can, for example, also be provided in sections as “gas/air bubbles” within the flexible material 50. In further embodiments, such weak points can also be formed by the flexible material 50 having a lower density in these sections.

The flexible material 50 causes the moldable material introduced into the cavity 36 to press against the first molding surface 37 during molding. The moldable material is pressed or shaped between the first molding surface 37 and the second molding surface 45.

To produce molded parts 200, the tool plate 34 and the tool plate 42 are movable relative to one another, so that introduced moldable material (e.g., plastic film) is held clamped between the first tool component 32 and the second tool component 40. Further devices, such as a clamping frame for holding a plastic film 80, can be provided for this purpose. The molding element 44 is then inserted into the cavity 36, wherein the plastic film 80 is pre-stretched. The medium is then introduced, wherein the flexible material 50 is deformed and the plastic film 80 in the cavity 36 is pressed against the first molding surface 37 via the second molding surface 45. In the cavity 36, cooling of a finally formed plastic film 82 can take place at least on the first molding surface 37. Appropriate drives and devices, e.g., toggle levers, can be provided for displacing the two tool plates 34 and 42 for molding, which can be controlled via the control unit 10.

In particular, the special design of a molding element 44 inserted into the cavity 36 of a first tool component 32 enables, for example, the production of molded bodies 200 with a simple structure and a simple design of the molding tool 30 with little effort and use of resources, since, for example, no negative pressure or positive pressure has to be generated in the cavity 36. Molding by “inflating” or deforming the flexible material 50 requires significantly less molding air and also allows simpler formation using molding tools 30, because no sealing is required. In addition, the “inflatable” section of the second molding surface 45 can be used to easily create undercuts 38, etc. (see FIGS. 11 to 13) without the need for additional slides or similar, for example. In further embodiments, the design of the molding tool 30 also enables the production of molded parts 200 from a film, which has a net-like structure, because no introduction of “molding air” or the generation of a vacuum, as is necessary with classic thermoforming tools and methods, is required.

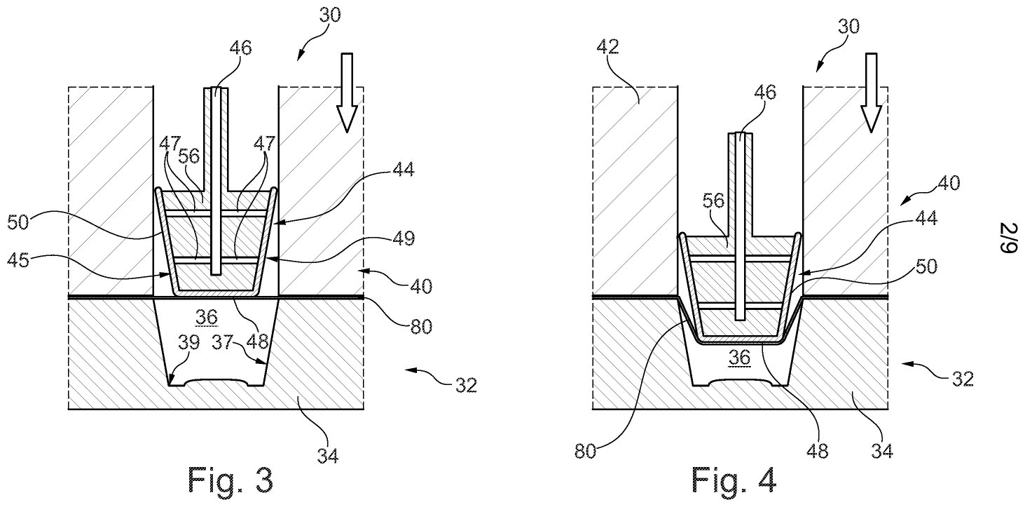

FIG. 3 shows a schematic representation of the molding tool 30 in FIG. 2 after the introduction of a moldable material, in this case a plastic film 80, according to some embodiments. The plastic film 80 has been inserted between the first tool plate 34 and the second tool plate 42 via a conveyor device. In the example shown, the plastic film 80 was heated beforehand. The first tool plate 34 and the second tool plate 42 have been moved towards each other by relative displacement, as indicated by the arrow, and thus hold the plastic film 80 firmly in position and orientation. At least one of the tool plates 34, 42 may have means necessary for holding and clamping.

FIG. 4 shows a schematic representation of the molding tool 30 in FIG. 2 in a first molding step, wherein the molding element 44 is moved downwards, as indicated by the arrow, according to some embodiments. The preheated plastic film 80 is pre-stretched. Here, the molding element 44 acts as a stretching aid. Stretching reduces the thickness of the plastic film 80 in the stretched regions, especially in the lateral regions.

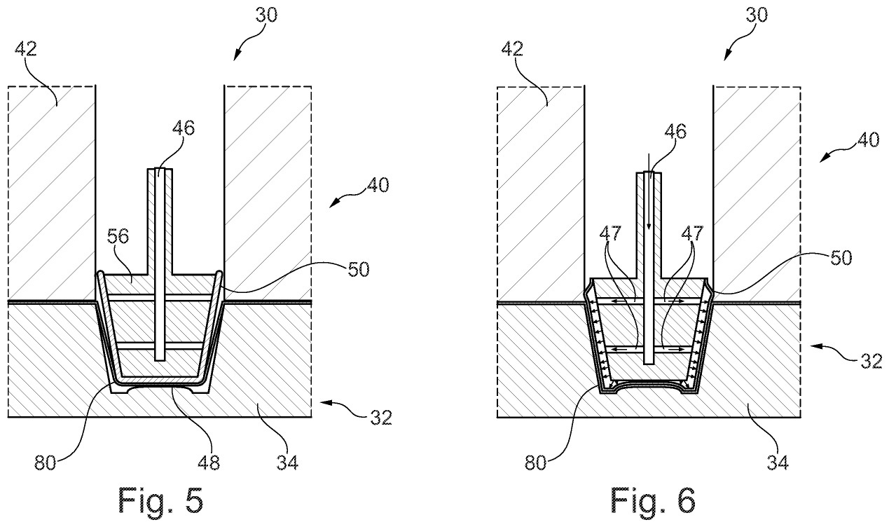

FIG. 5 shows a schematic representation of the molding tool 30 from FIG. 2 in a second molding step, according to some embodiments, after which the molding element 44 has reached its bottom dead center and is not moved down any further. In the embodiment example shown, the plastic film 80 is in contact with the first molding surface 37 only in the region of the lower molding surface 48 of the second molding surface 45. In further embodiments, the plastic film 80 may come into contact with the first molding surface 37 in further regions, in particular if the molding element 44 is designed in such a way that it already has the required shape and size in these regions for providing a molding pressure.

In still further embodiments, especially in embodiments in which the molding for a plastic film 80 takes place predominantly via a part of the molded element 44 whose second molding surface 45 is not deformed by the introduction of compressed air or similar, overpressure can take place after the bottom dead center has been reached in order to provide the required molding pressure as a result. Regions of the second molding surface 45 can provide compensation in the event of overpressure due to the flexible material 50 and the “air cushion” located behind it and therefore do not have a negative effect on the molding in this region.

FIG. 6 shows a schematic representation of the molding tool 30 from FIG. 2 in a third molding step, according to some embodiments, wherein compressed air is introduced via the main channel 46 and the secondary channels 47. This results in a deformation of the flexible material 50, which is pressed away from the molding body 56, so that the second molding surface 45, which in the embodiment example shown is formed entirely by the flexible material, presses the plastic film 80 against the first molding surface 37. As indicated in FIG. 6, an upper edge 230 can also be formed, because the flexible material 50 also provides a molding pressure in this region by the introduction of compressed air via the flexible material 50.

In the molding step shown in FIG. 6, in further embodiments, the plastic of the plastic film 80 can be “pressed away” laterally in the region of the lower molding surface 48 by the deformation of the flexible material 50 in this region with a view to FIG. 6, so that this region of the base 210 of a molded part 200 to be produced is thinner and the lower standing ring 240 (see FIG. 9) of the base 210 extending next to it is formed thicker. By deforming the flexible material 50, a material distribution and the formation of regions with different material thicknesses can be achieved.

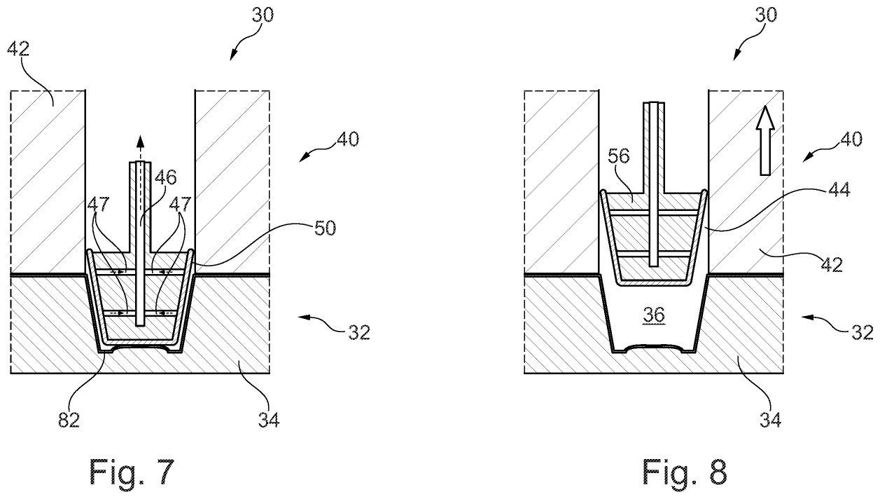

FIG. 7 shows a schematic representation of the molding tool 30 in FIG. 2 after molding the plastic film 82, wherein this now has the final shape, according to some embodiments. The plastic film 82 can cool and thus harden through contact with the first molding surface 37. The illustration in FIG. 7 shows that the molding air introduced can be discharged, e.g., extracted, via the main channel 46 and the secondary channels 47. In further embodiments, the molding air or another medium can be discharged in another way. After the molding air has been removed, the flexible material 50 reattaches itself to the surface of the molded body 56 and takes on its original shape. The molding process is then complete.

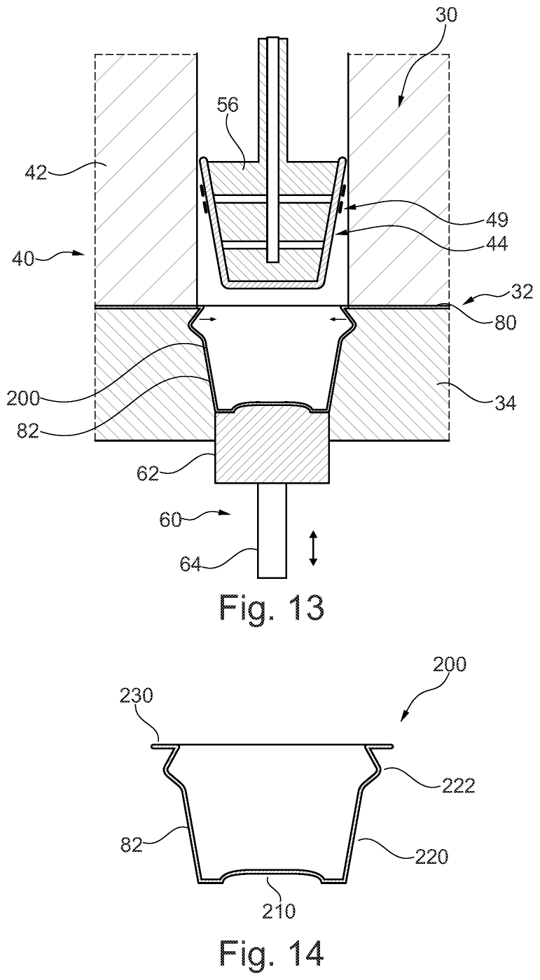

Subsequently, as shown in FIG. 8 as a schematic representation, the molding element 44 is moved upwards out of the cavity 36. In the region of the dashed lines, the tool plates 34, 42 can have cutting devices so that the produced molded part 200 can be removed from the film web. In further embodiments, only partial separation of the finished molded part 200 from the film web or detachment in a separate downstream station can take place. Analogous to the embodiment shown in FIG. 13, a finished molded part 200 can be ejected using an ejector 60, which can be arranged in the region of the base of the cavity 36.

FIG. 9 shows a schematic representation of a molded part 200, which can be produced with a molding tool 30 of the embodiment shown in FIGS. 2 to 8. The molded part 200 shown has a base 210 with a standing ring 240, a side wall 220 and an edge 230. The molded part 200 is rotationally symmetrical and includes a deformed plastic film 82. In the embodiment shown, the molded part 200 is a storage container in the food sector and, depending on the dimensions, can be designed as a bowl, cup or capsule (e.g., for coffee, etc.).

FIG. 10 shows schematic representations of a molding tool 30 for producing moldable materials in a further embodiment, wherein molded parts can be produced here, which do not have an edge 230 extending substantially orthogonally to the vertical axis of the molded part 200. Instead, molded parts can be produced that have a circumferential edge whose diameter is larger than the diameter of the manufactured molded part in a region directly below it. Such molded parts can, for example, be designed and used as drinking cups.

FIG. 11 shows a schematic representation of a molding tool 30 in a still further embodiment with a moldable material inserted, in this case a plastic film 80. The difference to the design in FIGS. 2 to 8 is that the cavity 36 also has an undercut 38. For this purpose, the second molding surface 45 of the molding element 44 may have a different flexible material 50 in the dashed region, so that, for example, a stronger deformation thereof can be achieved to ensure that a substantially uniform molding pressure occurs over the entire first molding surface 37 in the first cavity 36.

FIG. 12 shows a schematic representation of the molding tool 30 in FIG. 11 during the molding of the introduced plastic film 80, wherein in this embodiment, a medium in the form of compressed air is introduced via the main channel 46 and the secondary channels 47, so that the flexible material 50 is deformed in the region of the second molding surface 45. Here, the flexible material 50 is deformed more strongly in the region indicated by the dashed line in FIG. 11. The greater deformation may be due to the fact that there is more room for deformation in the region of the undercut 38. In addition, the use of a special flexible material 50 and its design (e.g., wall thickness) can be decisive for the deformation. In further embodiments, the compressed air introduced in the region of the undercut 38 can also be provided at a higher pressure, so that the flexible material 50 is deformed more strongly as a result. A separate air duct can be provided for this purpose, for example, or the secondary channels 47 are designed differently for the respective deformation regions (undercut 38 and remaining region). In further embodiments, the amount of compressed air provided and its inflow time and duration can also be regulated via a valve control. In addition, in further embodiments, cutting devices may be provided in the region of an edge 230 for a molded part 200.

FIG. 13 shows a schematic representation of a molding tool 30 in a still further embodiment after the molding of a moldable material, in this case a plastic film 80, wherein an ejector 60 is provided for ejecting a produced molded part 200. The ejector 60 is connected to an ejector rod 64, which can be displaced relatively in the direction of the cavity 36 as shown in FIG. 13. The ejector rod 64 is connected to a base element 62, which in the embodiment shown forms a bottom of the cavity 36. After molding the molded part 200, the ejector 60 can be moved vertically upwards, wherein the molded part 200 is ejected. For this purpose, the second tool plate 42 is first moved upwards to enable ejection. During ejection, the displaceable base element 62 presses the molded part 200 out of the cavity 36, wherein a bead 222 of the molded part 200 (see FIG. 14) may be briefly compressed in the region of the undercuts 38, as indicated by the arrows pointing towards each other. Such ejection can generally be carried out without problems and without damaging the molded part 200, depending on the design of the bead 222. Such ejection processes are common in the region of plastic parts with undercuts.

FIG. 14 shows a schematic representation of a further molded part 200, which can be produced in a molding tool 30 according to the embodiments shown in FIGS. 11 to 13. The molded part 200 has a base 210 and a circumferential side wall 220 extending from the base 210, which extends relatively steeply from the base 210. A bead 222 extends around the upper region of the side wall 220. At the upper end of the side wall 220, the molded part 200 has an edge 230 that runs essentially parallel to the base 210. In the embodiment shown, the wall thickness of the molded part 200 is the same everywhere in the base 210, in the side wall 220, in the bead 222 and in the edge 230, but can be varied in further embodiments by defining the distance between the first molding surface 37 and the second molding surface 45 before the medium is introduced, as described, for example, with reference to FIG. 6. The molded part 200 can be used, for example, as a cup in the field of food packaging, as a flower pot or in another field.

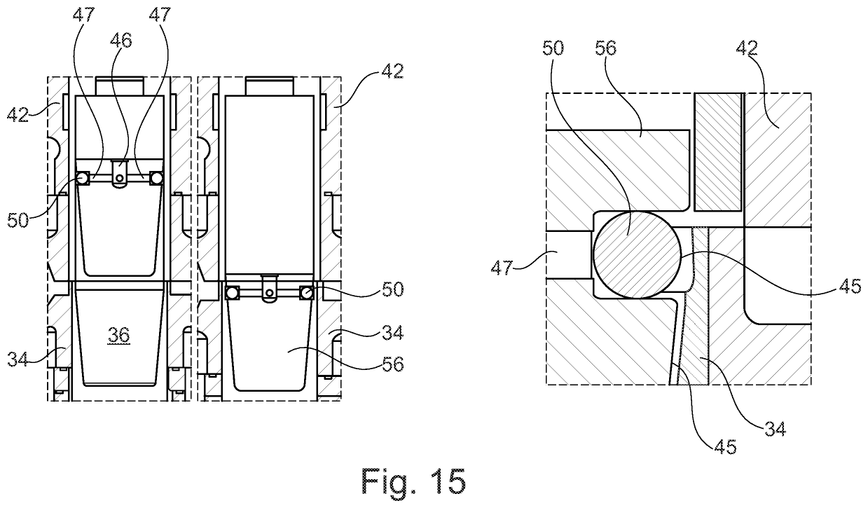

FIG. 15 shows schematic representations of a molding tool 30 for producing moldable materials in a still further embodiment, wherein a flexible material 50 is provided only in a circumferential groove in the region of the molding body 56. In this embodiment, the flexible material 50 is tubular and surrounds the groove as a ring or is accommodated in the groove. The ring preferably has connections to the secondary channels 47 arranged symmetrically around a vertical axis. In this embodiment, the design of the flexible material 50 is selected in such a way that, in an initial state without pressurization via introduced medium, the second molding surface 45 partially formed by the flexible material 50 is substantially flush with the remaining second molding surface 45 of the molded body 56. In such an embodiment, the molding and the molding pressure for a moldable material (plastic or fiber-containing material) can essentially only be provided via the molding body 56. After deformation of the introduced material, compressed air or another medium is then additionally introduced into the circulating, tube-like ring with a time delay, so that the flexible material 50 is deformed. The flexible material 50 then protrudes from the groove and causes the moldable material to expand in this region.

In further embodiments, openings and the associated secondary channels 47 can also be arranged asymmetrically about a vertical axis of a molded part 200 to be produced, so that, for example, the formation of surface structures, etc., is taken into account by a quantity- and position-dependent supply of compressed air or another medium. In still further embodiments, however, a homogeneous deformation of flexible material 50 can be ensured by a symmetrical distribution and increase in the number of outlet openings for the medium.

In still further embodiments, for example, compressed air can be introduced during the deformation of plastic films to support the deformation. For this purpose, for example, corresponding molding channels and molding openings can be provided in a molding element 44 in regions without flexible material 50. Finally, openings may also be provided in the first molding surface 37 for sucking in a film to support the molding process or to remove the water vapor escaping from a fiber-containing material during the production of molded parts 200.

In still further embodiments, the formation of a molding element 44 with a flexible material 50 provided in the contact region between the first tool component 32 and the second tool component 40 can additionally seal the cavity 36 or the mold space by the flexible material 50, so that no escape of fibers and/or (molding) air can occur.

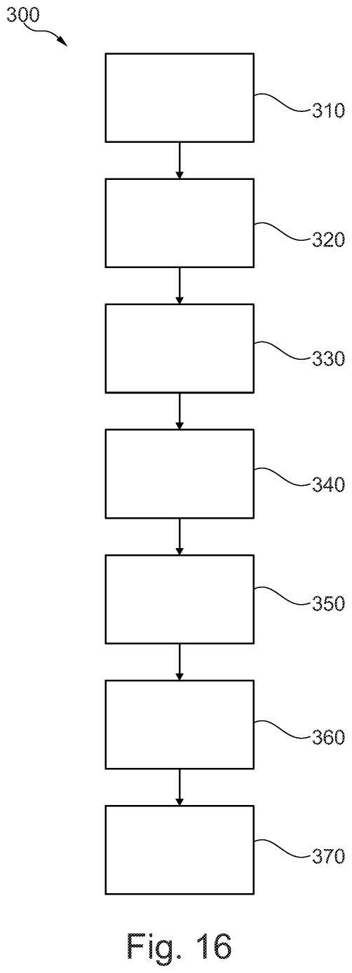

Finally, FIG. 16 shows a method 300 for producing molded parts 200 using a molding tool 30, according to some embodiments. In a first method step 310, moldable material is provided. The moldable material can be provided in different ways depending on the type of material (fiber-containing material, plastic film). Thus, the provision can also include the production and/or processing of a moldable material.

In a subsequent method step 320, moldable material is fed in. For example, when producing molded parts 200 from a plastic, the material can be fed in as a film web. The same applies to the production of molded parts 200 from films with a net-like structure. For example, a plastic film 80 can be placed between the tool plates 34 and 42, wherein the film is not yet introduced into a cavity 36. Fiber-containing material can be fed in via a material web, which can be produced in an upstream method step, for example.

In a subsequent method step 330, the moldable material is introduced into the cavity 36 of at least one molding tool 30. The introduction of moldable material can be achieved, for example, by direct introduction (e.g., blowing) of loose fibers into the cavity 36. Alternatively, a web (film, fiber layer) can be pressed into the cavity 36 via the molding element 44, as is known in thermoforming via a stretching aid or molding die, with the molding element 44 serving as a stretching aid. The moldable material can be stretched over the molding element 44 as a stretching aid until a bottom dead center of the molding element 44 is reached. In further embodiments, sufficient molding pressure may already be present, at least in part, to form finished molded regions of a molded part 200.

In a method step 340, the moldable material is then compressed by introducing a medium for deforming a flexible material 50, so that, depending on the embodiment, either the entire second molding surface 45 provides sufficient molding pressure due to the deformation of the flexible material 50 or additional deformation occurs only in a region of the second molding surface 45 with a flexible material 50.

Subsequently, in a method step 350, the pressure on the flexible material 50 is reduced by discharging the previously introduced medium, so that the flexible material 50 returns to its unactuated orientation. In a method step 360, the molding tool 30 is then opened, and the molded part 200 produced in the cavity 36 is subsequently ejected in a method step 370. During pressing and already when the moldable material is introduced into the cavity 36, it can be tempered in order to support the molding process or to achieve hardening after molding.

The above procedure can then be repeated for a new molded part 200.

Advantageously, with the embodiment described herein, molded parts can be produced with simple means and undercuts 38 or other structures can be realized in a molded part without complex tool designs and movement sequences. When producing molded parts from a plastic film 80, it is even possible to completely dispense with the introduction of molding air or the generation of vacuum, so that the molding tool 30 can be further simplified and the control unit 10 is significantly simplified. With plastic films 80 and fiber-containing materials, molded parts 200 can be produced, which can provide a defined wall thickness by targeted deformation of a flexible material 50.

In particular, less molding air is required as a medium, especially when processing plastic films 80, as is the case with classic thermoforming methods. This can be achieved, for example, by the molding element 44 serving both as a stretching aid and being “inflated” by a second molding surface 45 made of a flexible material 50 in order to achieve the final molding for a plastic film 80.

### LIST OF REFERENCE NUMBERS

10 Control unit
20 Feeding device
30 Molding tool
32 First tool component
34 First tool plate
36 Cavity
37 First molding surface
38 Undercut
39 Edge region
40 Second tool component
42 Second tool plate
44 Molding element
45 Second molding surface
46 Main channel
47 Secondary channel
48 Lower molding surface
49 Region
50 Flexible material
56 Molded body
60 Ejector
62 Base element
64 Ejector rod
80 Plastic film
82 Deformed plastic film
100 Molding device
200 Molded part
210 Base
220 Side wall
222 Bead
230 Edge
240 Standing ring
300 Method
310 Method step
320 Method step
5 330 Method step
340 Method step
350 Method step
360 Method step
370 Method step

1. A molding tool for producing molded parts from a moldable material with at least a first tool component and a second tool component, wherein
the first tool component has a cavity into which moldable material can be introduced,
the second tool component has a molding element, which can be introduced into the cavity of the first tool component to produce a molded part,
the molding element has a second molding surface via which, in a closed state of the molding tool, moldable material can be pressed against a corresponding first molding surface of the cavity of the first tool component, and
at least one section of the second molding surface has a flexible material which, in the closed state of the molding tool, can be deformed by introducing a medium via the molding element in order to press the moldable material against the first molding surface.

2. The molding tool according to claim 1, wherein the cavity has at least one undercut and the moldable material can be pressed into the undercut of the cavity by the at least one section of the second molding surface having an at least partially flexible material.

3. The molding tool according to claim 1, wherein the second molding surface, which inserts into the cavity of the first tool component in the closed state of the molding tool, is formed entirely by the flexible material.

4. The molding tool according to claim 1, wherein the second molding surface has regions with a different structure or material thickness of the flexible material.

5. The molding tool according to claim 1, wherein the second molding surface has at least two different flexible materials that differ with respect to a deformability of the flexible materials.

6. The molding tool according to claim 1, wherein the flexible material extends annularly around the molding element.

7. The molding tool according to claim 1, wherein the flexible material contacts with the molding element in a resting state and the molding element has openings for the medium for deforming the flexible material in regions with the flexible material.

8. The molding tool according to claim 7, wherein the openings differ from one another in shape, configuration, and/or position according to a material thickness of the flexible material, a composition of the flexible material, a position or location of the flexible material, a type of the flexible material used, and/or the configuration of the first molding surface.

9. The molding tool according to claim 1, wherein the flexible material has reinforcements and/or weak points which influence a deformability of the flexible material.

10. The molding tool according to claim 1, wherein the second molding surface has at least two portions made of the flexible material, which differ with respect to a deformability of the flexible material.

11. The molding tool according to claim 1, wherein the flexible material includes silicone and/or thermoplastic elastomers.

12. The molding tool according to claim 1, wherein the cavity of the first tool component and/or the molding element of the second tool component can be heated via at least one heating device.

13. A method for producing molded parts from a moldable material using a molding tool having at least a first tool component and at least a second tool component, wherein the first tool component has a cavity with a first molding surface, and wherein the second tool component has a molding element with a second molding surface which at least partially has a flexible material, which forms at least a portion of the second molding surface, the method comprising:
introducing a moldable material into the cavity of the first tool component,
introducing the molding element of the second tool component into the cavity of the first tool component by relative displacement of the first tool component and the molding element, wherein the second molding surface of the molding element moves the moldable material at least in regions against the first molding surface, and
introducing a medium via the molding element in the region of the flexible material, wherein the flexible material is deformed and, as a result of the deformation, the flexible material presses the moldable material against a corresponding section of the first molding surface.

14. The method according to claim 13, wherein the cavity has at least one undercut and the moldable material is pressed over the flexible material of at least the portion of the second molding surface when the medium is introduced into the undercut of the cavity.

15. The method according to claim 13, wherein after the molding of the molded part in the cavity, the introduction of the medium is terminated, wherein the flexible material resumes its shape present before the introduction of the medium and subsequently the molding element of the second tool component is moved out of the cavity.
